(19) United States
(12) Patent Application Publication
(10) Pub. No.: US 2023/0342551 A1
(43) Pub. Date: Oct. 26, 2023

(54) METHODS AND SYSTEMS FOR PROVIDING USER INPUT RECOMMENDATIONS

(71) Applicants: Typewise Ltd., Schlieren (CH); ETH Zürich, Zürich (CH)

(72) Inventors: David Eberle, Basel (CH); Janis Berneker, Zurich (CH); Luca Campanella, Zurich (CH); George Roberts, Zurich (CH); Federico Betti, Zurich (CH)

(21) Appl. No.: 18/142,195

(22) Filed: May 2, 2023

Related U.S. Application Data
(63) Continuation-in-part of application No. 17/568,212, filed on Jan. 4, 2022.
(60) Provisional application No. 63/337,470, filed on May 2, 2022.
(60) Provisional application No. 63/134,347, filed on Jan. 6, 2021.

(51) Int. Cl. G06F 40/279; G06F 40/242; G06F 40/166

(52) U.S. Cl. CPC G06F 40/279; G06F 40/242; G06F 40/166

(57) ABSTRACT

A method for providing user input recommendations includes receiving, by a recommendation generation engine, an indication that a message addressed to a user has been received. The method includes analyzing, by the recommendation generation engine, at least one word within the message. The method includes determining, by the recommendation generation engine, a plurality of candidate input recommendations, based on analyzing the at least one word. The method includes identifying, by the recommendation generation engine, a subset of the plurality of candidate input recommendations, each of the subset associated with a confidence score that satisfies a threshold level of confidence. The method includes modifying, by the recommendation generation engine, a graphical user interface displayed to the user to include a display of at least one of the identified subset associated with the confidence score that satisfies a threshold level of confidence.

### CROSS-REFERENCE TO RELATED APPLICATIONS

This application claims priority to U.S. Provisional Patent Application 63/337,470, entitled, “Methods and Systems for Providing User Input Recommendations,” and is a continuation-in-part of U.S. patent application Ser. No. 17/568,212, filed on Jan. 4, 2022, entitled, “Methods and Systems for Modifying User Input Processes,” which itself claims priority from U.S. Provisional Patent Application No. 63/134,347, filed on Jan. 6, 2021, entitled, “Methods and Systems for Modifying User Input Processes,” each of which is hereby incorporated by reference.

### BACKGROUND

The disclosure relates to interacting with software applications. More particularly, the methods and systems described herein relate to functionality for improving data entry into a user interface of a software application by generating user input recommendations.

Conventional systems for receiving user input include only limited functionality for analyzing an initial user input and making customized recommendations for subsequent user input based on the analysis. Conventional systems may provide a generic recommendation—such as determining that a user has typed “thank” and suggesting that the next word be “you”—but such autocompletion functionality is not typically customized based on the user's line of work, department, conventional slang or jargon or standard business terms, or any other aspect of the user context that may benefit from customization.

Therefore, there is a need for technical tools that improve processes by which user interfaces receive user input and recommend additional data to include as user input.

### BRIEF SUMMARY

In one aspect, a method for generating and providing user input recommendations includes receiving, by a recommendation generation engine, an indication that a message addressed to a user has been received. The method includes analyzing, by the recommendation generation engine, at least one word within the message. The method includes determining, by the recommendation generation engine, a plurality of candidate input recommendations, based on analyzing the at least one word. The method includes identifying, by the recommendation generation engine, a subset of the plurality of candidate input recommendations, each of the subset associated with a confidence score that satisfies a threshold level of confidence. The method includes modifying, by the recommendation generation engine, a graphical user interface displayed to the user to include a display of at least one of the identified subset associated with the confidence score that satisfies a threshold level of confidence.

In another aspect, a method for generating and providing user input recommendations includes receiving, by a graphical user interface provided by an application executing on a computing device, user input representing at least a first word entered by a user of the computing device, the first word including at least one character. The method includes accessing, by the application, at least one word entered by the user prior to the entering of the first word. The method includes analyzing, by the application, the first word and the at least one word entered prior to the entering of the first word. The method includes determining, by the application, a plurality of candidate input recommendations, based on analyzing the first word and the at least one word entered prior to the entering of the first word. The method includes identifying, by the application, a subset of the plurality of candidate recommendations, each of the subset associated with a confidence score that satisfies a threshold level of confidence. The method includes modifying, by the application, the graphical user interface to include a display of at least one of the identified subset associated with the confidence score that satisfies a threshold level of confidence.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a flow diagram depicting an embodiment of a method for generating user input recommendations;

FIG. 1B is a flow diagram depicting an embodiment of a method for generating user input recommendations;

FIG. 1C is a flow diagram depicting an embodiment of a method for generating and providing user input recommendations;

FIG. 2A is a block diagram depicting an embodiment of a system for generating user input recommendations;

FIG. 2B is a block diagram depicting an embodiment of a system for generating user input recommendations;

FIG. 3 is a flow diagram depicting an embodiment of a method for generating user input recommendations; and

FIG. 4 is a flow diagram depicting an embodiment of a method for generating user input recommendations; and

FIGS. 5A-5C are block diagrams depicting embodiments of computers useful in connection with the methods and systems described herein.

### DETAILED DESCRIPTION

In one aspect, the methods and systems described herein provide autocorrection functionality leveraging artificial intelligence (e.g., via at least one machine learning engine) to improve a rate of user input by detecting what the user wants to input and by learning how the user communicates (especially given that how users communicates and what kind of information is input into a user's computing device varies significantly from person to person). In a keyboard context, people use different words, different word-combinations, and have different typing behavior (e.g., touch locations, typing speed); the methods and systems described herein use this type of information to better interpret what the user intends to input, as well as to recommend additional input the user should provide. One application of this technology is a virtual smartphone keyboard. Other applications may include functionality to enhance input through hardware keyboards, voice-to-text, wearables (e.g., smartwatches or smart glasses), and brain-computer-interfaces.

In one aspect, the autocorrection functionality provided by the methods and systems described herein provides support for users who speak and enter data in multiple languages, something that's common across the globe (e.g., a user speaks Spanish at home and English at work, or a user sends Short Message Service text messages to one message recipient in one language but to another message recipient in another language). Typical autocorrections fail in such embodiments, because they typically try to correct, for example, a Spanish word into a similar-looking English word, which leads to increased errors and higher levels of inefficiency and user frustration.

In one aspect, the autocorrection functionality provided by the methods and systems described herein provides support for users who enter data into computing devices that includes words in slang, dialects, etc., including data used by countries (e.g., Arabic speaking countries), population groups (e.g., teenagers), and other groups of people (e.g., language in use by an enterprise or company). Traditional autocorrections use standard language dictionaries, and then force the user into accepting replacements of user-entered data with standard word usage or go through the process of rejecting the autocorrection. The methods and systems described herein adapt to a user's language style by analyzing user-entered data and generating autocorrect recommendations and/or automatically correcting a user's data input when a level of confidence in the recommended correction exceeds a threshold level of confidence.

In another aspect, the autocorrection functionality provided by the methods and systems described herein provides support for users executes on the computing device of the user (e.g., “offline” or “on-device”). This results in personalization to data input received from a user occurs locally on the user's computing device, which provides an increased level of privacy to the user over conventional systems, which often require that the user authorize transmission of their data (including personal or confidential data, such as banking passwords, healthcare identifiers, and other personal data) over one or more computer networks to third party computers where the computation occurs, all of which decreases the user's privacy.

In some embodiments, executing autocorrection and/or autocomplete functionality may provide reduced response time and/or cost as well. For example, in an embodiment in which the system analyzes input and generates recommendations for corrections and/or predicts text that the user should include as subsequent user input, if 100,000 users make 100,000 typos that need to be evaluated for errors, generate error correction recommendations, have error corrections recommended, and receive user input regarding whether or not to accept the recommendation, and each interaction requires a transaction between the user's local device and a remote server that provides the autocorrection functionality, one or more of the 100,000 users may experience reduced response time and/or the organization hosting the server may experience increased cost due to additional traffic and processing time required of the server. Therefore, autocorrection and/or autocomplete and/or other predictive functionality that can execute on a user's local device may provide many benefits both to the user and to the provider(s) of the autocorrection functionality.

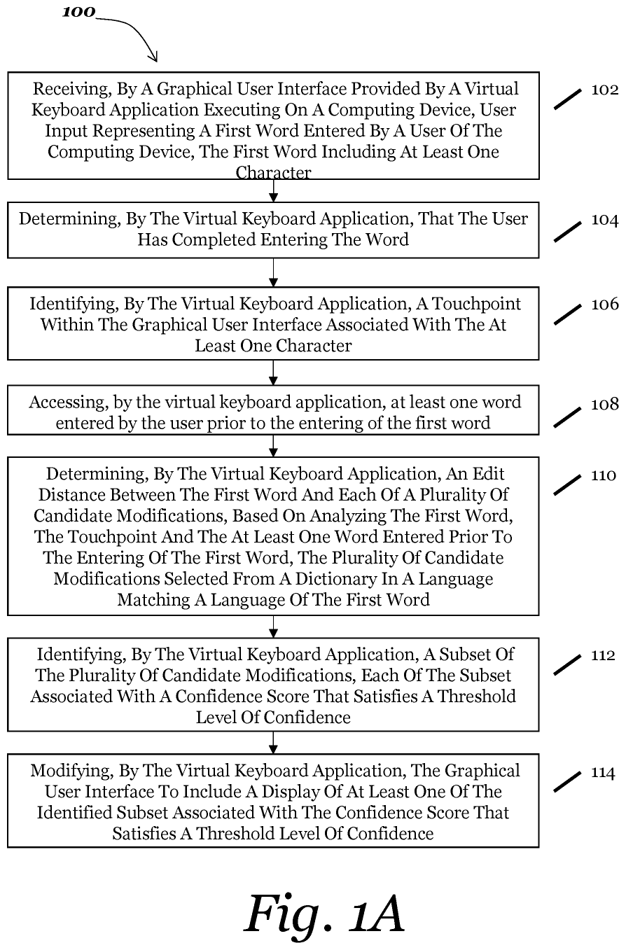

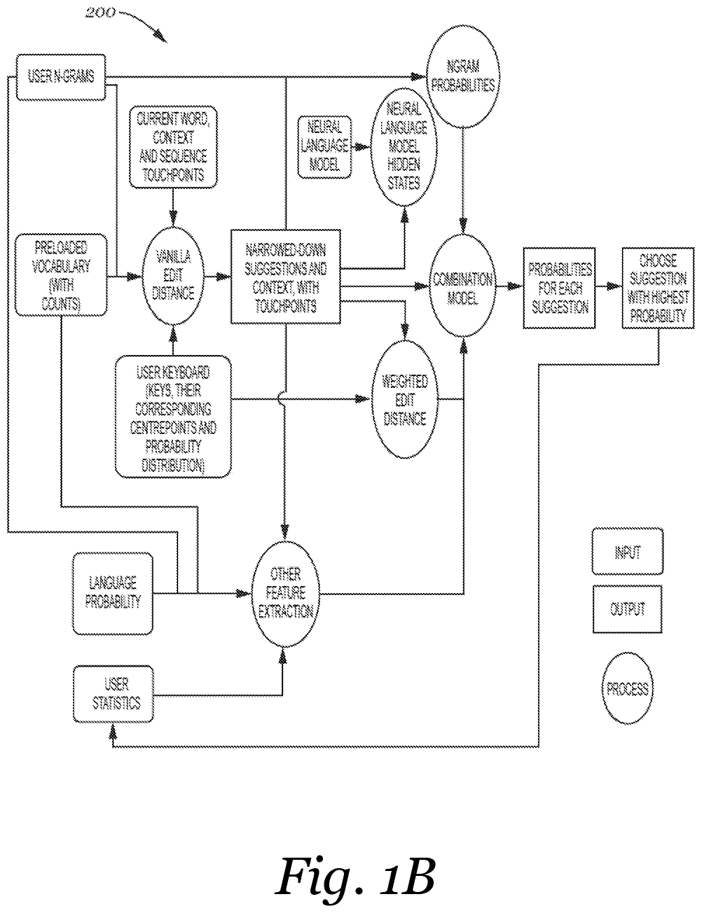

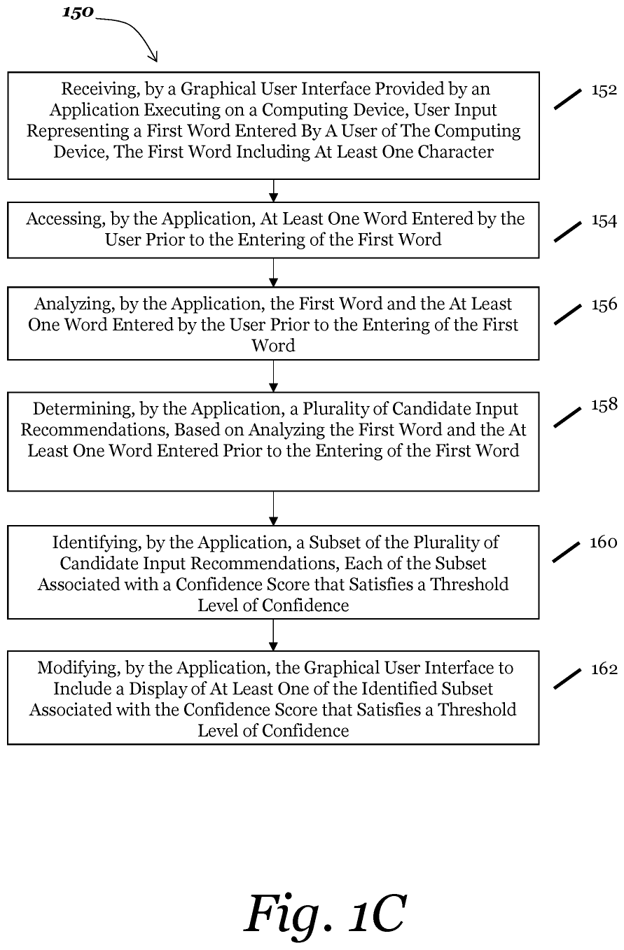

The methods and systems described herein may include functionality for generating suggestions to users for automatically correcting (“autocorrecting”) a word received as user input. Referring now to FIG. 1A, in brief overview, a flow diagram depicts one embodiment of a method 100 for generating and displaying a recommendation for modification of user input. The computer-implemented method 100 for generating and displaying a recommendation for modification of user input includes receiving, by a graphical user interface provided by a virtual keyboard application executing on a computing device, user input representing a first word entered by a user of the computing device, the first word including at least one character (102). The method includes determining, by the virtual keyboard application, that the user has completed entering the word (104). The method includes identifying, by the virtual keyboard application, a touchpoint within the graphical user interface associated with the at least one character (106). The method includes accessing, by the virtual keyboard application, at least one word entered by the user prior to the entering of the first word (108). The method includes determining, by the virtual keyboard application, an edit distance between the first word and each of a plurality of candidate modifications, based on analyzing the first word, the touchpoint and the at least one word entered prior to the entering of the first word, the plurality of candidate modifications selected from a dictionary in a language matching a language of the first word (110). The method includes identifying, by the virtual keyboard application, a subset of the plurality of candidate modifications, each of the subset associated with a confidence score that satisfies a threshold level of confidence (112). The method includes modifying, by the virtual keyboard application, the graphical user interface to include a display of at least one of the identified subset associated with the confidence score that satisfies a threshold level of confidence (114).

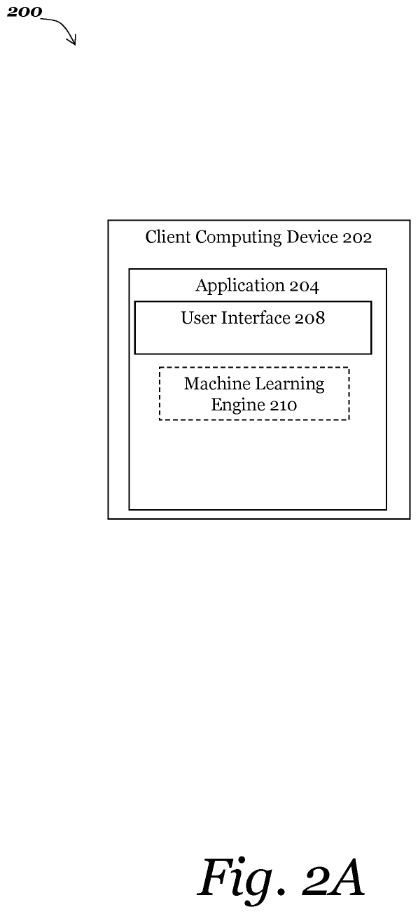

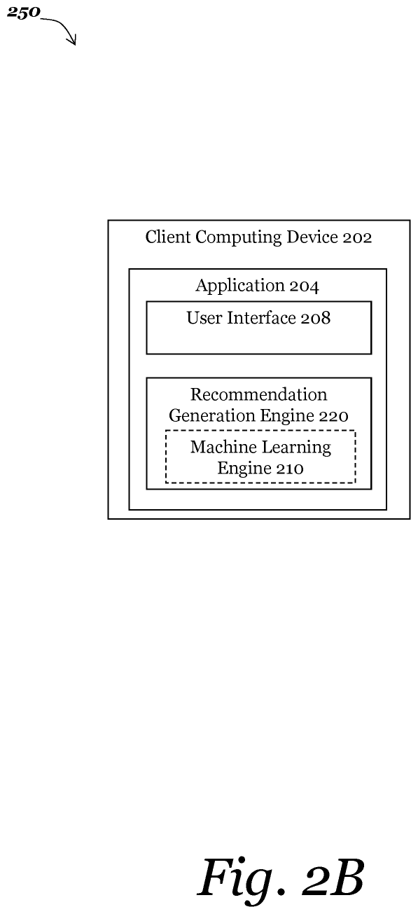

Referring now to FIG. 1A, in greater detail and in connection with FIG. 1B and FIG. 2, a flow diagram depicts one embodiment of a method 100 for generating and displaying a recommendation for modification of user input. The computer-implemented method 100 for generating and displaying a recommendation for modification of user input includes receiving, by a graphical user interface provided by a virtual keyboard application executing on a computing device, user input representing a first word entered by a user of the computing device, the first word including at least one character (102).

In one embodiment, when a user interacts with an application on a computing device that requires text input, the application may display a virtual keyboard interface; when the user touches a display screen of the computing device to touch a portion of the screen displaying a portion of the virtual keyboard interface (e.g., in order to “type” into the interface); and an operating system of the computing device transmits to the virtual keyboard interface information about the user's touchpoint on the screen (e.g., x,y coordinates representing the user's touch on the screen, hold duration, movement path). The application may use the information about the user's touchpoint on the screen to identify a character associated with the touchpoint. The application may execute an autocorrection method, using as input the touchpoints pressed (as well as, in some embodiments, information about touchpoints pressed prior to the touchpoint most recently pressed), with their corresponding characters, with context information and with the user's past behavior. Coordinates identifying where on a screen of a device a user touched and whether they swiped whilst pressing (including the movement path along which they swipe), along with the start and end timestamp of the touch, may be referred to as touchpoints.

Words that are considered to be “real” or valid words by the system may be referred to as a vocabulary. This may include a preloaded vocabulary within an application as well as user-specified or other additional user-words.

A sequence of n elements in a sequence may be referred to as an n-gram. In one embodiment, n-grams include unigrams [one-word with no context, e.g., (‘this’), (‘is’), (‘an’), (‘example’)] and bigrams [two-word sequences, e.g., (‘this’, ‘is’), (‘is’, ‘an’), (‘an’, ‘example’)].

Inputs to the system 200 may include user n-grams. This may include at least two dictionaries—unigrams and bigrams, which are completely built on the user's device (the start value may be empty). Each entry also contains the language that was being typed when the word was entered. When a user types a word they haven't typed before, the system may add the word to the user's unigram dictionary with a count value of one. If the word typed is already in the unigram dictionary, the system may add one to that unigram count value. This also contains the number of times the suggestion was rejected (e.g., the system corrected to this word and the user changed it back to the original word). When the user types a sequence of two words they haven't typed before, add it to their bigram dictionary with a count value of one. If the sequence has been typed before, add one to the bigram count value. If the word is at the start of a sentence, a ‘start-of-sentence’ token is added as the first value.

Inputs to the system may include an initial vocabulary, such as, by way of example, a dictionary for each downloaded language of ˜70-100 k common words in each language and the number of times each occurs in a number of common texts in the corresponding language.

The method includes determining, by the virtual keyboard application, that the user has completed entering the word (104). Inputs to the system may include a current word, a previous word and touchpoints of sequence. In some embodiments, when a user types what the system identifies as a stop character, and this input is the word just typed, the word before the previous stop character, and the touchpoints of the entire sequence (previous word+intermediate stop character+current word). The ‘word just typed’ and ‘word before previous stop character’ may be the sequences of characters closest to each touchpoint. For example, if the user types ‘this is’, because they have typed the stop character ‘ ’, the current word is “is”, the previous word is “this” and the entire sequence of touchpoints include all of the touchpoints for “this is”. Stop characters are any characters the system determines signifies that the user is finished typing a word, including, for example, a space, a full stop, a comma, a colon, etc.

The method includes identifying, by the virtual keyboard application, a touchpoint within the graphical user interface associated with the at least one character (106). The method may also include before determining the edit distance, identifying a language in which the user entered the first word.

The method may include before determining the edit distance, determining whether the first word matches a word in the dictionary in the language matching the language of the first word and determining that the first word is not in the dictionary.

The method may include identifying a language in which the user typed the first word; identifying a dictionary that is in the identified language from a plurality of dictionaries stored on the computing device; determining whether the first word matched a word in the identified dictionary; and determining that the first word is not in the identified dictionary.

The method includes accessing, by the virtual keyboard application, at least one word entered by the user prior to the entering of the first word (108).

The method includes determining, by the virtual keyboard application, an edit distance between the first word and each of a plurality of candidate modifications, based on analyzing the first word, the touchpoint and the at least one word entered prior to the entering of the first word, the plurality of candidate modifications selected from a dictionary in a language matching a language of the first word (no). In one embodiment, the method includes selecting the plurality of candidate modifications from a dictionary including words in a dialect of a language. In another embodiment, the method includes selecting the plurality of candidate modifications from a dictionary including a subset of words contained in a second dictionary and associated with a population group having a threshold level of probability of using the subset of words. In another embodiment, the method includes selecting the plurality of candidate modifications from a dictionary including words in a slang version of a language.

A measurement of the difference between two strings within received user input may be referred to as a “vanilla edit distance”. This may be the number of operations to change one string into another string. These operations may include, without limitation, deletion, insertion, substitution or transposition. For example, the edit distance of ‘hlelo’->‘hello’ is 1, because it requires a single character transposition. As another example, the edit distance of ‘thisis’->‘this is’ is 1, because it requires a single space insertion. As a further example, the edit distance of ‘hello’->‘hello’ is 0, because the strings are identical.

A development upon the vanilla edit distance described above may include “Keyboard-weighted edit distance”. The edit distance for this type of distance metric depends on where within the user interface a user touched, upon the keyboard layout, upon the time between touches, and upon the presence of diacritics in either string.

The method includes identifying, by the virtual keyboard application, a subset of the plurality of candidate modifications, each of the subset associated with a confidence score that satisfies a threshold level of confidence (112). In one embodiment, identifying the subset of the plurality of candidate modifications includes executing, by the virtual keyboard application, a neural network component to determine a probability of a candidate modification having a threshold level of accuracy.

In one embodiment, a “vanilla edit” method executes to narrow down suggestions generated by the system prior to providing the initial set of suggestions to a user for autocorrecting a word or phrase. The method may include calculating the “vanilla edit distance” to every candidate word in the vocabulary and keeping only those below a certain maximum edit distance. A maximum edit distance depends on word length; shorter words may have a lower maximum edit distance. Maximum edit distance may depend on the minimum edit distance found. For example, if the input word is ‘hello’, the suggestion ‘hello’ has an edit distance of 0, so the system will only keep words with an edit distance <=1 (minimum found edit distance+1). The system may also consider that the user could have accidentally inserted a stop character (e.g., ‘ele.phant->‘elephant’). For this, the system may calculate the edit distance of the combination [‘previous word’+‘stop character’+‘current word’] to every word in the vocabulary. The system may consider the possibility that the user could have accidentally hit the key neighboring a stop character. For this, the system may calculate the probability of every letter in the word being a stop character (based on the user's touchpoints and probability distribution, as described above). For each split location (defined as each probable stop character) with a probability over a certain threshold, the system may calculate the edit distance to all other words in the vocabulary. If the words at all different split locations are in the dictionary and combine to make a word below the maximum edit distance, the system may add it to a list of suggestions. For example, ‘thisjisjgoing’->‘this is going’ has an edit distance of two, because two spaces were substituted for ‘j’s. Other feature extraction includes:
length of noisy word, suggestion, and previous words;
number of counts of suggestion in the preloaded vocabulary;
number of separate words in the suggestion (e.g., ‘thisis’->‘this is’, means 2 words have been suggested);
language probability;
and how many times the user has ‘undone’ the suggestion (e.g., the system may change ‘ralk’ into ‘talk’ and the user changes the suggestion back to ‘ralk’).
   Neural language model hidden states may include the previous 15 characters (e.g., the “context”), which are first run through the GRU, producing the ‘context’ hidden state vector. Using this as the initial hidden state, each suggestion is then passed through the GRU, with the final hidden state being output.

The system may generate weighted edit distance determinations for certain suggestions (e.g., narrowed down suggestions). For example, the system may determine that the weight of insertion of an apostrophe is lower than insertion of any other character. As another example, the weight of substituting letter_1 for letter_2 with a diacritic (if no swipe is detected) is only slightly higher than substituting for letter_2 without the diacritic. The weight of substituting a letter may depend on the touchpoint location, which may be used to determine the probability of each key being pressed. For example, if the touchpoint is exactly between two characters, the weight of substituting for either character is identical and approximately equal to 0.5. If the touchpoint is very close to the center of the ‘a’ key, but slightly away from it, the weight will be close to, but not exactly, 0. The weight of transposition is reduced if the keys are on different sides of the keyboard, with a weight that depends on time between touches (if the time is very short, the transposition weight is lower.

In some embodiments, the system uses a parameter that biases the word the user actually typed, meaning the system may control the confidence level before an autocorrection is applied. If, for example, the system determines that a user is often undoing the system-applied autocorrection, the system may increase this parameter, thus only providing corrections when a level of confidence exceeds a threshold level of confidence (which may be, for example, a higher threshold level than a default threshold). For an example of this, if the user types the word ‘biden’, which is not in the system's default dictionary, the combination model may determine that the probability that ‘biden’ is the correct word is just 0.4. ‘Bidet’, however, is given a probability of 0.6. If the ‘keep current word’ bias is 0.3, the ‘biden’ probability will be increased to 0.7, and so will be preferred over ‘bidet’ in a subsequent autocorrect process.

Additive smoothing may be used to calculate the n-gram probabilities, in the following equations, K represents a constant smoothing factor, V is the total vocabulary size (length of the user unigrams), C_{T} is the total number of occurrences of all words (sum of user unigram values) and C_{ngram}(x) is the n-gram counts of word x. x|y means x given y, so in the sequences ‘this is’, x=‘is’ and y=‘this’.

$$\begin{matrix}{P}_{u n i g r a m} ( x ) = \frac{{C}_{n gram} ( x ) + K}{{C}_{T} + V \times K} \\ {P}_{b i g r a m} ( x \vert y ) = \frac{{C}_{bigram} ( x \vert y ) + K}{{C}_{unigram} ( y ) + V \times K}\end{matrix}$$

In one embodiment, the system includes a fully connected neural network 210 that combines one or more of the above features to determine a probability of a possible suggestion being the correct suggestion (or of being a suggestion that satisfies a threshold level of accuracy or that is likely to increase a level of accuracy associated with a suggestion). From the suggestions and their corresponding features, the combination model may output scores for each suggestion. The system may then choose to modify a display of a user interface of a virtual keyboard application to include a display of the suggestion with the highest score. The structure of this model may separate the features into two parts. The first part is the hidden state vector. This may be a highly complex, uninterpretable feature, and thus requires a higher degree of non-linearity than the other features. For this reason, the vector is passed through two fully connected neural network layers (with RELU activations), before being combined with the other feature vector. This combination is then passed through a fully connected layer, before the final softmax (sigmoid) layer. The target is 0 if the suggestion is not the correct suggestion and 1 if the suggestion is correct.

In another embodiment, the system may include a separate model used to process the language model hidden state, to output a probability of a sequence given the context. This would replace the extra layers before combination with the feature vector.

The method includes modifying, by the virtual keyboard application, the graphical user interface to include a display of at least one of the identified subset associated with the confidence score that satisfies a threshold level of confidence (114). The method may include receiving user input including an instruction to replace the first word with the at least one of the identified subset. The method may include receiving user input including an instruction not to replace the first word with the at least one of the identified subset. The method may include receiving user input including an instruction to add the first word to the dictionary.

Character-based neural language model may refer to a recurrent neural network (RNN) that tokenizes the input text into characters and then outputs the probability distribution of the proceeding character. This may be used to calculate the probability of proceeding words and the probability of entire sequences. In one embodiment, the system may implement a type of RNN known as a Gated Recurrent Unit (GRU). GRUs function the same as RNNs, except that they have an internal gating mechanism that helps the network know which part of the context are important.

Inputs to the system may include a neural language model. In one embodiment, at the start of a new input sequence, every time a token (e.g., a character) is input to the GRU, the hidden state (a vector inside the GRU cell, which can be thought of as the ‘memory’ of the GRU) is updated based on the weights calculated during the training of the GRU. This hidden state is output after each token and fed back into the GRU. In this way, a language model is created that ‘understands’ the context that came before it. The token can be any character in the language's alphabet, a ‘start-of-sentence’ token, or an ‘unknown’ token if the character isn't in the language's alphabet. In one embodiment, this may be implemented using Tensorflow Lite on Android. In another embodiment, this may be implemented using CoreML on iOS.

Inputs to the system may include an identification of a language probability. A dictionary which has all the user languages may be identified, as well as the probability that the current sentence is in each language.

User keyboards (keys and their corresponding touchpoints and probability distributions) may be dynamically modified. As indicated above, coordinates identifying where on a screen of a device a user touched and whether they swiped whilst pressing (including the movement path along which they swipe), along with the start and end timestamp of the touch, may be referred to as touchpoints. Touchpoints may be associated with one or more characters. The systems and methods described herein may modify the association between a touchpoint and one or more characters—for example, a default touchpoint may indicate an x,y coordinate pair is associated with the letter “a”, but the system may execute a method to modify the x,y coordinate based on where on the screen a user actually touches when the user intends to enter the letter “a.” A preloaded value for use in a method for making such a modification is a dictionary {key: (touchpoint, distribution parameters)}, referred to as the keyboard dictionary. A key may be the specific key on the keyboard (for example the first key is the one in the top left, which is the letter ‘q’ in the English layout, or ‘a’ in the French layout). Distribution parameters may be 2D Gaussian parameters around each key that model where a user can touch when they aim for the center of the given “key”; this may be updated in an online fashion.

Each user may have access to different keyboard dictionaries for each keyboard layout they use (e.g., one for portrait and one for landscape keyboard layout). These dictionaries may then be updated as the user uses each keyboard layout. The system may analyze where on a screen each user touches when they are trying to touch an ‘a’ in a user interface, for example. Over time, the system may move the touchpoint location away from the default value to the average of their touchpoints. If a user types a word and doesn't change it, the system concludes that these touchpoints all correspond to the most probable keys, based on the keyboard dictionary. If a user types a word and the autocorrection changes the word and substitutes any characters, if the user then accepts this correction (e.g., doesn't change it) the system may determine that the touchpoints correspond to the corrected key. Using these touchpoints and keys, the system may move the touchpoint associated with the character away from the default value. For example, the user may typically touch to the left of the ‘a’ key when intending to write the letter ‘a’, and x,y coordinate pair for the location at which the user actually touches the screen becomes the new value. In some embodiments, the application modifies the user interface to display the representation of the character at the location on the screen where the user typically touches when the user intends to input that character. In other embodiments, the application does not modify the user interface but associates the location that the user touches with the character the user intends to touch and, optionally, automatically corrects what the user did input to reflect what the user intended to input.

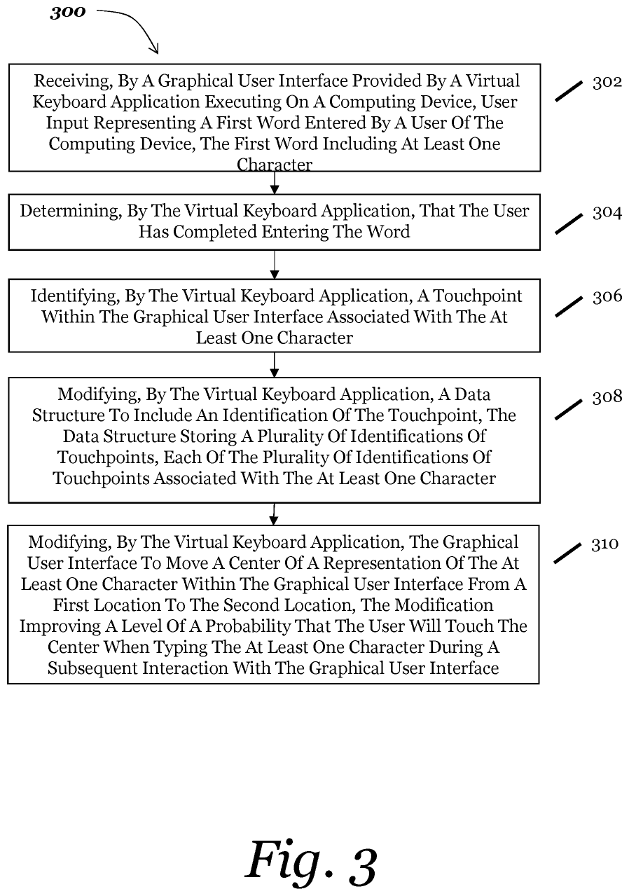

Therefore, and referring now to FIG. 3, a method 300 for modifying a virtual keyboard layout generated by a virtual keyboard application includes receiving, by a graphical user interface provided by a virtual keyboard application executing on a computing device, user input representing a first word entered by a user of the computing device, the first word including at least one character (302). The method includes determining, by the virtual keyboard application, that the user has completed entering the word (304). The method includes identifying, by the virtual keyboard application, a touchpoint within the graphical user interface associated with the at least one character (306). The method includes modifying, by the virtual keyboard application, a data structure to include an identification of the touchpoint, the data structure storing a plurality of identifications of touchpoints, each of the plurality of identifications of touchpoints associated with the at least one character (308). The method includes modifying, by the virtual keyboard application, the graphical user interface to move a center of a representation of the at least one character within the graphical user interface from a first location to the second location, the modification improving a level of a probability that the user will touch the center when typing the at least one character during a subsequent interaction with the graphical user interface (310).

Using these touchpoints and keys, the system may model the distribution of all key-touches as a 2D Gaussian. The system may calculate the covariance matrix (S) of this and mean (m). This allows the system to calculate the probability of the user pressing each key, given a touchpoint (x). To do this, the system may calculate the probability density function of each key using the equation for a multivariate normal distribution and the calculated parameters.

$$P D {F}_{j} = \frac{1}{\sqrt{det ( {\sum }_{j} )}} {e}^{- \frac{1}{2} {( x - {μ}_{j} )}^{T} {\sum }_{j}^{- 1} ( x - {μ}_{j} )}$$

The system may then normalize these densities between all keys so that the total probability is one.

$$= \frac{P D {F}_{j}}{{\sum }_{k} P D {F}_{k}}$$

In some embodiments, the systems and methods described herein may include implementing a weighted Damerau-Levenshtein distance. Although this distance is conventionally implemented to determine as a linear distance between keys, conventional approaches do not typically teach or suggest using such a distance to solve a probabilistic problem or to calculate, given the user's previous key touches, what is the probability of the user having pressed each key given the touchpoint.

The methods and systems described herein may also be used for correcting words entered before the last word typed. For example, the user types:

The shlp sells bread.

After seeing the first two words, the system may correct shlp to ship. After they type ‘sells’, however, the system may analyze the subsequent input, determine that ‘shop’ would be a more accurate suggestion, and therefore corrects it again to ‘shop’. The system 200 may, therefore, include functionality for saving a word that has been through the autocorrect process and execute the autocorrect process described in FIG. 1A multiple times for the same word.

The methods and systems described herein may provide functionality for identifying a weighted edit distance, in a system in which there are a plurality of language models (e.g., one for each language in which user input may be received), in a system including a combination model. Combining multiple features allows the combination model to decide what inputs are important and if there are any important relationships between the features. For example, the combination model will learn that longer words are more likely to have more typos in them, so it should behave differently to short words. Also, similarly to ensemble models, having two language models with different operating principles allows the application to extract a more reliable prediction.

Referring now to FIG. 1B and in connection with Table 1 below, a flow diagram depicts an embodiment of the inputs and outputs used in the method 100. As shown in FIG. 1B, user n-grams, preloaded vocabulary, user keyboard types, and current words, context, and sequence touchpoints are inputs used in determining a vanilla edit distance, which itself is an input to determining a narrowed-down subset of suggestions and context with touchpoints. Language probability, use statistics, user n-grams, preloaded vocabulary, and the narrowed-down subset of suggestions are inputs to feature extraction functionality, which itself is an input to a combination model that generates probabilities to each suggestions and enables the selection of a suggestion with the highest probabilities. Other inputs to the combination model include n-gram probabilities and neural language models and weighted edit distances.

TABLE 1
Inputs and Outputs

| Input | Output |
|---|---|
| Every word accepted by the user (i.e., they type | User n-grams |
| it and then don't change it, or the system may | |
| autocorrect it and they don't change it) and the | |
| previous context (list of strings) | |
| Touchpoints of every intended key for each | User keyboard (keys, |
| keyboard layout (dictionary of key: [x, y] | their corresponding |
| vector) | touchpoints and |
| | multivariate gaussian |
| | parameters) |
| All words typed in the current session (list of | Language |
| strings) | probability |
| How many times a word has been shown to the | User statistics |
| user by the language model. | |
| How many times the user has chosen each | |
| word shown by the language model. | |
| How many times a user has undone the | |
| autocorrection suggestion. | |
| Current word (string) | Vanilla edit distance |
| User words (a set of all words typed by the | |
| user) | |
| User keyboard (a dictionary of keys and their | |
| associated touchpoints) | |
| Initial vocabulary (a preloaded set of words, | |
| common to all users) | |
| Typed words, narrowed down suggestions and | Other features |
| context (strings) | |
| Initial vocabulary (a preloaded dictionary of | |
| words and counts, common to all users). | |
| Language probability (dictionary of languages | |
| installed by user, and probability of each being | |
| used in the current session) | |
| User unigrams (dictionary) | |
| Narrowed down suggestions (such as, for | n-gram probabilities |
| example, a list of strings) | |
| Context (strings) | |
| User n-grams (unigram and bigram | |
| dictionaries) | |
| Narrowed down suggestions (such as, for | Neural language |
| example, a list of strings) | model hidden states |
| Context (strings) | |
| Neural language model (TFlite/CoreML) | |
| Narrowed down suggestions (such as, for | Weighted edit |
| example, a list of strings) | distance |
| Context (strings) | |
| Touchpoints (e.g., [x, y] vector for all touches), | |
| start and end timestamp, and movement path | |
| (list of floats) | |
| User keyboard (dictionary of keys with their | |
| corresponding touchpoints and multivariate | |
| Gaussian parameters (2 × 2 covariance matrix | |
| and 2 × 1 mean)) | |
| Narrowed down suggestions (list of strings) | Combination model |
| N-gram probabilities (for example, and | word probabilities |
| without limitation, a list of floats) | |
| Neural language model hidden states (for | |
| example, and without limitation, a 256- | |
| dimensional vector) | |
| Weighted edit distance (float) | |
| Other features (list of floats) | |
| Current word, context, and sequence | Corrected word |
| touchpoints | sequence |
| User n-grams | |
| User keyboard (keys, their corresponding | |
| touchpoints and probability distribution) | |
| Initial vocabulary (with counts) | |
| Neural language model | |
| Language probability | |

In some embodiments, the methods and systems described herein may include execution of a neural network. By way of example, the system may execute a method for training a different neural network for each (human) language that may be received as user input. Databases of text (including of transcribed text) in one or more languages may be used for testing. In one embodiment, the first 90% of sentences are used to train an n-gram model, the next 5% are used to build training data for the neural network (a random 80% of this subset for training and 20% for cross-validation), and the final 5% are used for testing the results.

In some embodiment, the system may include a noise model based on the keyboard layout to insert errors into the training data for training. For this, the correct string is passed through a function that inserts, deletes, transposes or inserts any keyboard character (including spaces and punctuation) at random. A symmetric gaussian is assigned to each key (this may be a multivariate gaussian), and the gaussian is sampled for each intended character. This gives a new touchpoint and a new key. A higher gaussian noise level may be used for training compared to testing. For each word in the training corpus, the system may apply the noise model and then run it through the vanilla edit distance calculator, taking every suggestion. For example, the original word might be ‘hello’, which gets corrupted to ‘helol’, providing the suggestions [‘hello’, ‘hell’, ‘he lol, ‘cello’, etc.]. The various features described above are extracted for each of these suggestions (weighted edit distance, n-gram probabilities, neural language model probabilities etc.), resulting in a feature vector (length may change in the future depending on features used, but in this instance, it is 268×1). If the suggested word is equal to the correct word (which can only happen either one time for each word—i.e., when the suggestion is ‘hello’ in this case), the system may set the label y=1, and for all other cases set the label y=0. The cross-validation data is similarly processed, and the system may elect a neural network that performs best on this data (e.g., exceeds a threshold level of acceptable performance as specified by a user). A single unit sigmoid layer at the output, with the loss function being binary cross entropy and the optimizer ‘Adam’ used with an inverse time decay scheduler may execute until meeting the early stopping criterion that loss doesn't improve for 30 rounds, whereby the best performing epoch is taken. Also, accuracy, precision, recall and AUC are all logged to ensure that the lowest loss will also be the best performing network. The network may be converted into CoreML and TFLite, with no compression necessary because the model size is small and inference speed is fast.

The system may also analyze a number of different metrics, to minimize the chance of there being specific bugs/weak points in execution of the methods.; for example, by determining whether a correct word is not included in a dictionary or the system vocabulary, whether a word with a closer edit distance was chosen, whether a word with the same edit distance was chosen, whether a word with a larger edit distance was chosen, whether a “noisy” word is already in a vocabulary, so the autocorrection procedure didn't change it back to the correct word (e.g., ‘hello’ being turned into ‘hell’ by noise), and whether too much noise added (the noise may be configured to be larger than a maximum edit distance, so the word wasn't in the narrowed down suggestions from vanilla edit distance). The system may also look at sentences from a test set and, if the autocorrect fails for a word, “color” the word according to which error occurred.

The methods and systems described herein may therefore provide functionality for identifying a weighted edit distance, in a system in which there are a plurality of language models (e.g., one for each language in which user input may be received), in a system including a fully connected neural network.

In some aspects, the method for generating an autocorrect suggestion may include segmenting, by a first machine learning model, user inputs into separate characters, and assigning, by a machine learning model, a character probability to each character.

Although FIG. 3 described a method for modifying a virtual keyboard layout, other methods are described herein, including methods for improving other types of input devices or functionality. That is, the methods and systems described herein are not limited to improving virtual keyboards. In one aspect, the methods and systems described herein provide functionality for improving a user interface within one or more specific types of application (e.g., instead of modifying every user interface available in every application on a computing device, the system may include functionality for improving particular, targeted types of applications, such as an email client or a texting client).

In another aspect, the methods and systems described herein provide functionality for correcting errors in voice transcription applications.

In another aspect, the methods and systems described herein provide functionality for correcting errors in user input received via a physical keyboard, through execution of a method similar to the method described above for the virtual keyboard autocorrect, except that the probability distribution for the weighted Damerau-Levenshtein may be discrete (e.g., there might be no touchpoints—a user either hits the right key or the wrong key).

In another aspect, the methods and systems described herein provide functionality for correcting errors generated through an optical character recognition process (e.g., for hand-writing or scanned documents) through execution of a method similar to the method described above for the virtual keyboard autocorrect, except that the probability distribution for the weighted Damerau-Levenshtein is weighted by the probability over each character. In such an embodiment, the system may begin learning from users to see how they write different letters.

In another aspect, the methods and systems described herein provide functionality for correcting errors generated through brain-computer interfaces.

In another aspect, the methods and systems described herein provide functionality for correcting errors through use of an autocorrection SDK, which may be used in other applications. Such methods may include generation of an estimation of possible key locations on popular (physical desktop) keyboard. Instead of, or in addition to user n-grams, an additional language model may be used that was trained with data from the specific application for which the SDK is to be provided. In this way, the neural network may achieve more accurate results in the application-specific context (e.g., emails) or for a specific user (e.g., a CRM application where often company-specific terms are used). Therefore, the methods and systems described herein may include a computer-implemented method for generating and displaying a recommendation for modification of user input, the method including receiving, by a graphical user interface provided by an application executing on a computing device, user input representing a first word entered by a user of the computing device via a physical keyboard, the first word including at least one character; determining, by the application, that the user has completed entering the word; identifying, by the application, a touchpoint on the physical keyboard associated with the at least one character; accessing, by the application, at least one word entered by the user prior to the entering of the first word; determining, by the application, an edit distance between the first word and each of a plurality of candidate modifications, based on analyzing the first word, the touchpoint, and the at least one word entered prior to the entering of the first word, the plurality of candidate modifications selected from a dictionary in a language matching a language of the first word; identifying, by the application, a subset of the plurality of candidate modifications, each of the subset associated with a confidence score that satisfies a threshold level of confidence; and modifying, by the application, the graphical user interface to include a display of at least one of the identified subset associated with the confidence score that satisfies a threshold level of confidence.

In some embodiments, the methods and systems described herein may provide functionality that uses data input and machine learning not only for autocorrection purposes but also to identify a specific user. In a keyboard context, the application may use information like touchpoints, words typed, and word-combinations typed to determine if the same user is using the device as the user that typically enters the data into the device. This could be used to lock the device when suspicious behavior is noticed. This functionality could also work with other types of interfaces.

The methods and systems described herein may include functionality for generating suggestions to users for one or more words to include in a plurality of words. The methods and systems described herein may include functionality for generating suggestions to users for one or more sentences to include in a plurality of words, including, without limitation, for generating suggestions for paragraphs and entire documents. Such methods may be used in connection with functionality for generating and displaying a recommendation for modification of user input.

Referring now to FIG. 1C, in brief overview, a method 150 for generating and providing user input recommendations includes receiving, by a graphical user interface provided by an application executing on a computing device, user input representing at least a first word entered by a user of the computing device, the first word including at least one character (152). The method 150 includes accessing, by the application, at least one word entered by the user prior to the entering of the first word (154). The method 150 includes analyzing, by the application, the first word and the at least one word entered prior to the entering of the first word (156). The method 150 includes determining, by the application, a plurality of candidate input recommendations, based on analyzing the first word and the at least one word entered prior to the entering of the first word (158). The method 150 includes identifying, by the application, a subset of the plurality of candidate recommendations, each of the subset associated with a confidence score that satisfies a threshold level of confidence (160). The method 150 includes modifying, by the application, the graphical user interface to include a display of at least one of the identified subset associated with the confidence score that satisfies a threshold level of confidence (162).

Referring now to FIG. 1C, in greater detail and in connection with FIGS. 1A, 1B and 2A, a method 150 for generating and providing user input recommendations includes receiving, by a graphical user interface provided by an application executing on a computing device, user input representing at least a first word entered by a user of the computing device, the first word including at least one character (152). The user input may be one word. The user input may be a plurality of words. For example, the user input may be a paragraph. The method may include determining, by the application, that the user has completed entering a first word.

As depicted in FIG. 2A, a computing device 202 may execute an application 204, which generates and modifies a display of a user interface 208. The application may be a virtual keyboard application. The application may be an application generating and/or updating a graphical user interface receiving user input via a hardware keyboard. The application may be an application generating and/or updating a graphical user interface receiving user input via any method for receiving user input. The application may include functionality for generating new text and may be referred to as AI-writing software. The application may be an application for analyzing text and generating user input recommendations. The application, as shown in shadow in FIG. 2A, may execute a machine learning engine 210. Referring now to FIG. 2B, the application 204 may execute a recommendation generation engine 220 which in turn executes or is in communication with one or more machine learning engines 210. The machine learning engine 210 may be a large language model capable of executing generative artificial intelligence procedures.

Referring back to FIG. 1C, the method 150 includes accessing, by the application, at least one word entered by the user prior to the entering of the first word (154). Accessing the at least one prior entered word may occur as described above in connection with FIG. 1A.

The method 150 includes analyzing, by the application, the first word and the at least one word entered prior to the entering of the first word (156). Analyzing the at least one prior entered word and the first word may occur as described above in connection with FIG. 1A.

The method 150 includes determining, by the application, a plurality of candidate input recommendations, based on analyzing the first word and the at least one word entered prior to the entering of the first word (158). Determining the plurality of candidate input recommendations may include selecting at least one candidate input recommendation from a database of words associated with the user. The plurality of candidate input recommendations may include one or more words, including without limitation phrases, sentences, paragraphs, or entire documents. The method may include selecting the plurality of candidate input recommendations from a database of words associated with a type of an application for which the user input is provided. The method may include selecting the plurality of candidate input recommendations from a database of words associated with an employer of the user. The method may include selecting the plurality of candidate input recommendations from a database of words associated with a group of users that includes the user providing the user input. By way of example, and without limitation, the system may select the plurality of candidate input recommendations from a collection (e.g., dictionary or database or other data store) of words that are associated with an increased level of effectiveness of communication (such as when the user is providing user input to an electronic mail program) over a threshold level of effectiveness as specified by the user or an entity associated with the user. As another example, the collection of words may be associated with communications that the user or other similar users previously used and which were associated with receiving positive feedback to the communications (e.g., words that were used in customer service tickets for which recipients of the service later provided a high rating, or words that were used in sales communications that were subsequently associated with a higher likelihood of closing a sale than sales communications that did not include the words in the collection of words). As another example, a user may be associated with an entity, such as a business, that has specified at least one key performance indicator and the system may analyze user input provided by the entity and identified as having included or otherwise satisfied the at least one key performance indicator; the system may then determine one or more words from the analyzed user input that is associated with satisfaction of the at least one key performance indicator and use the determined word or words (including phrases, sentences, or multiple sentences) in subsequent recommendations for improving subsequently received user input.

The method 150 includes identifying, by the application, a subset of the plurality of candidate recommendations, each of the subset associated with a confidence score that satisfies a threshold level of confidence (160).

The method 150 includes modifying, by the application, the graphical user interface to include a display of at least one of the identified subset associated with the confidence score that satisfies a threshold level of confidence (162).

The methods described herein may be combined. For example, the methods for autocorrection described above may be combined with methods for providing candidate input recommendations. As another example, the methods for providing candidate input recommendations may execute the methods for autocorrection after receiving user input representing at least one word and before accessing prior words or determining candidate input recommendations. As still another example, after receiving user input regarding whether or not to implement a recommendation, the methods for providing candidate input recommendations may execute a grammar correction process as described above in connection with autocorrect functionality, which may improve a level of recommendation for subsequent words or groups of words.

The method may include identifying a context associated with the user input and determine the plurality of candidate input recommendations based on analyzing at least the first word and the context. By way of example, the method may include identifying an attribute of the context for use in determining the plurality of candidate input recommendations; as a simplistic example, if the identified context is “sales email” and has a first attribute such as “successful sale” and a second attribute such as “included phrase XYZ from collection ABC”, the method may include determining to recommend “phrase XYZ” from the collection ABC in the user input. Phrases, as will be understood by those of skill in the art may include a plurality of words, sentences, or paragraphs. As described in greater detail below, the methods and systems described herein may implement one or more neural networks to identify commonalities across types of input and to make recommendations as to additional or revised user input to include.

Therefore, the methods and systems described herein may access collections of words that have been associated with at least a threshold level of efficiency specified, for example, by users of the systems based upon an objective of the user input and of the application processing the user input. Therefore, although the description of the methods and systems above refer to correcting a word or words, the methods and systems described herein may include functionality for recommending a new word or words to include in the user input, and such recommendations may include words or phrases (e.g., including full sentences); that is, the methods and systems described herein may also or instead provide autocompletion and/or sentence prediction functionality. The user—or an entity associated with a user, such as a school or employer—may customize the recommendations based on the context of the message, such as, for example, specifying that different collections of words (e.g., by identifying one or more data sets for use) should be drawn upon for recommendations when the user input is received from the user as a member of a particular group (such as a business unit or social group or grade level or department or other entity). As a result, the systems and methods herein may provide technological solutions to a technical problem of increasing the usefulness and context sensitivity of automated analysis and recommendation generating systems including those conventionally referred to as autocorrect tools. The method includes identifying a subset of the plurality of candidate modifications, each of the subset associated with a confidence score that satisfies a threshold level of confidence. The method includes modifying the graphical user interface to include a display of at least one of the identified subset associated with the confidence score that satisfies a threshold level of confidence.

In one embodiment, the system described herein includes a combination of neural networks to analyze the user input, identify a context of the user input, identify a collection of words from which to select recommendations, and to make recommendations. In one embodiment, the system includes a plurality of neural networks. For example, the system may include a first neural network and a second, user-specific neural network. As another example, the system may include a first neural network, a second organization-specific neural network, and a third neural network specific to a user associated with the organization of the second organization-specific neural network.

The system may include a neural network and a sentence extraction model. In such an embodiment, the sentence extraction model may analyze the user input and determine whether to receive additional user input before making a recommendation. For example, the system may include a character-level language model component executing beam search decoding of user input; the method therefore may include executing the beam search decoding of user input until a probability of a prediction based on the decoding output reaches or is lower than a predetermined threshold level. The system may keep the beam search decoding process active for access by a different (e.g., higher scoring) beam at a subsequent time to the time of decoding the user input. When the sentence extraction model determines that there is sufficient user input available, the sentence extraction model analyzes the user input and determines whether or not to make a recommendation. If the sentence extraction model identifies a recommendation, the sentence extraction model may provide the recommendation back to the system for determining whether the recommendation satisfies a threshold level of confidence and for displaying the recommendation via the graphical user interface. In an embodiment in which the sentence extraction model generates a plurality of recommendations, the sentence extraction model may rescore each of the plurality of recommendations; the sentence extraction model may access and apply one or more rules to determine whether and how to rescore each of the plurality of recommendations. For example, a sample rule may indicate that a longer recommendation (e.g., having more characters than another recommendation) may have a higher score even if there is a lower level of probability that the recommendation will satisfy a threshold level of accuracy because there is a higher amount of characters saved for the user than a shorter recommendation.

The first characters of the extracted sentences (e.g., user input) may often match what the user is typing; therefore, to improve efficiency and user satisfaction and to provide a technical approach that provides a threshold level of predictions, a minimum matching prefix length may be computed for each sentence extracted from user input. For each extracted sentence, the algorithm goes over the dataset and computes, starting from the first character of the sentence, for every character, what is the probability that that prefix is followed by the remaining part of the sentence. At inference time, a threshold is chosen, for example 0.80. This means that the system will show the sentence as prediction when the user has typed enough characters of the prefix that the model is 80% sure the rest of the sentence will follow. The method may also execute an alpha rescoring functionality to promote longer sentences: as with the neural model, longer sentences in this approach may receive a higher score. The method may also execute functionality providing up-sampling/rescoring of messages with successful answers/good ratings; that is clients scores are incorporated to judge business value: sentences that appear more often in messages with a higher customer satisfaction score may receive a higher score and are suggested more often.

In one embodiment, the sentence extraction model implements a classification approach to identifying one or more recommendations for user input. In such an embodiment, given a context encoded as a vector by a language model, the sentence extraction model may use a classification layer to select a sentence candidate having a higher level of probably of accuracy than a threshold level of accuracy (e.g., making the selection from among candidates extracted from a corpus during a training process, as described in greater detail below). The sentence extraction model may modify the sentence (e.g., using string distance metrics such as edit distance or BLEU score) for use with the existing user input (e.g., to match spelling and/or grammar). With a classification approach, even if the user input is not an exact match for a particular candidate, the system may identify that the candidate should still be recommended. For instance, if a user types “Thanks”, the prediction may be for “Thank you for contacting us” because both are classified in a context identified as having a “thank you” meaning.

In another embodiment, the sentence extraction model implements a language model where decoding is constrained only to the top K (e.g., 2500) sentences and the decoding stops when a level of probability is less than a threshold level of probability. The sentence extraction model may apply one or more rules to increase a level of flexibility and allow recommendations that do not have a high level of matching along one measure but exceed a threshold level of matching along another measure that is given higher priority by the system.

In some embodiments, the sentence extraction model analyzes not just the current message to identify context and generate predictions but may also analyze a previous set of user input (e.g., previous documents typed by the user, previous messages exchanged between the user and the same or similar message recipients, etc.). The system may apply a summarization model to generate a summary of previous user input for analysis by the sentence extraction model. The system may generate a vector from the previous user input for analysis by the sentence extraction model. Other data that the sentence extraction model may analyze includes, without limitation, time of day, user metadata (e.g., gender, age, job role, etc.); these data may also be summarized by summarization models or encoded into vectors for use as input into the method. Other data that the sentence extraction model may analyze includes, without limitation, identifying a purpose of the user input—e.g., generating text with the goal of responding to a different type of text that has been previously classified and for which there may be different language models to apply. As an example, the system may determine that the user input relates to a conversation about “complaints” or “order confirmations” and apply different language models accordingly. Other data that the sentence extraction model may analyze includes, without limitation, a placement of a cursor; as an example, the user input may be segmented into a plurality of portions each associated with a label based on position within the user input—e.g., greeting, body, signature, etc. —or based on metadata within the user input (e.g., headings). The system may then apply one or more rules regarding what type of recommendations to include or how highly to score a recommendation based on the placement of the cursor; for example, applying a rule indicating that the system show not recommend text such as “best regards” if the word “best” appears in the second line of the message or in a section labelled “body”. Different message categories (e.g., lost packets or return request messages) may be treated differently and be served with different language models, as is the case for templates, described below. Scoring may take into consideration data including customer feedback to previous recommendations; e.g., the system may use the average positivity of customer feedback to a message incorporating a particular recommendation and the score will then vary not based on a characteristic of the language in the recommendation but due to the type of customer interaction and/or feedback.

As indicated above, the system may provide recommendations for words, sentences, or a plurality of words, including paragraphs and entire documents. Therefore, the system may provide recommendations for completing a variable within a sentence. By way of example, for a candidate recommendation include text such as “I'd be happy to set up an XX-minute meeting with you”, the system may determine based on data such as that described above (user attributes, context, recipients, previous user input, etc.) that this is a type of communication relating to, for example, an initial consultation and that this user typically changes “XX-minute” to “45-minute” and the system may modify the candidate recommendation prior to its display to the user to include “45-minute” instead of the original text.

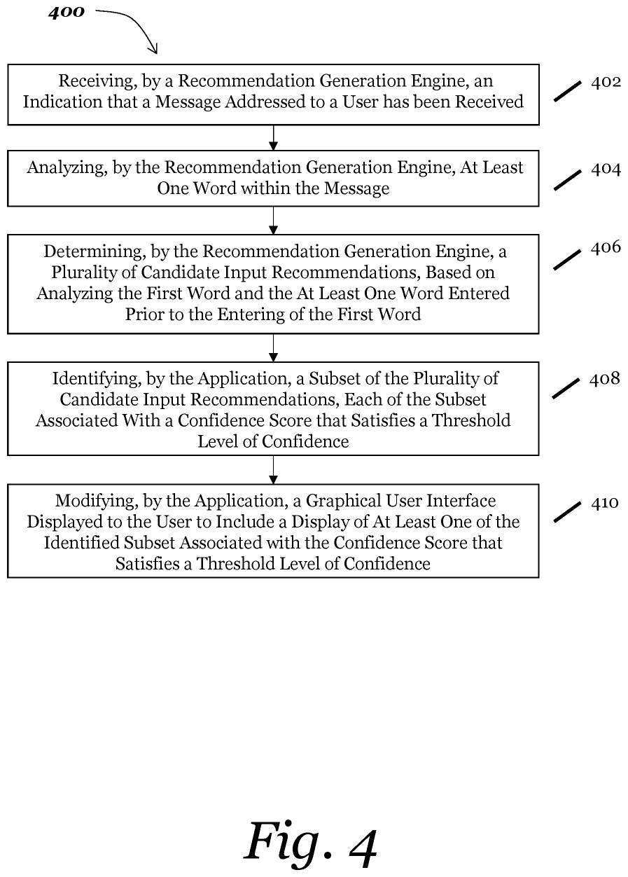

Referring now to FIG. 4, in brief overview, a method 400 for generating and providing a user input recommendation includes receiving, by a recommendation generation engine, an indication that a message addressed to a user has been received (402). The method 400 includes analyzing, by the recommendation generation engine, at least one word within the message (404). The method 400 includes determining, by the recommendation generation engine, a plurality of candidate input recommendations, based on analyzing the at least one word (406). The method 400 includes identifying, by the recommendation generation engine, a subset of the plurality of candidate input recommendations, each of the subset associated with a confidence score that satisfies a threshold level of confidence (408). The method 400 includes modifying, by the recommendation generation engine, a graphical user interface displayed to the user to include a display of at least one of the identified subset associated with the confidence score that satisfies a threshold level of confidence (410).

Referring now to FIG. 4 in greater detail and in connection with FIGS. 1-C, 2A-B, and 3, the method 400 includes receiving, by a recommendation generation engine, an indication that a message addressed to a user has been received (402). As indicated above, the application 204 may be in communication with third party services, including without limitation, customer relationship management databases, email servers, customer support systems, and other systems through which users may receive messages and for which the application 204 may generate user input recommendations. In some embodiments, the recommendation generation engine may request updates regarding received messages instead of waiting to receive update notifications.

The method may include selecting a type of implementation for generating user input recommendations based upon analyzing one or more aspects of at least one word within the message.

The method 400 includes analyzing, by the recommendation generation engine, at least one word within the message (404). In some embodiments, a recommendation generation engine 220 depicted in FIG. 2B may execute a machine learning engine 210, which may include or be in connection with a sentence extraction model. The sentence extraction model may analyze previous user input and instruct the system to prepopulate the user interface with recommendations instead of displaying a default user interface. For example, the method may include determining, by a sentence extraction model, based upon previous user input that the user is responding to a message of a particular type or that the received message is of a particular type and that the user will be composing a response to the message at a subsequent time to the execution of the analysis at (404) and, before the user begins entering user input into the user interface, the sentence extraction model may identify one or more recommendations for text to use in such a response and provide a pre-written message the user can accept or modify instead of having to begin generating user input from a blank input screen.

The method may include predicting a specific template to use in generating the candidate input recommendations. The method may select a template based on analyzing an email history associated with a particular user. The method may select one or more user input recommendations based on analyzing an email history associated with a particular user. The method may further analyze occurrence data generated from analyzing previously generate user input sets to improve predicting sentences or entire paragraphs. To generate a template, the method may include extracting common text, such as entity names or signature data, from a sample previously generated user input set, which may result in an improved template and in seeding the model with improved training information. Previously generated user input sets may be retrieved from third party sources, such as by executing one or more Application Programming Interfaces (APIs) calls to databases, including for example, company databases such as customer relationship management databases or enterprise resource planning databases. By analyzing messages and data from such datasets, the system may identify commonalities between messages and improve sentence and/or message recommendations based on the analysis. By generating a “smart reply” that includes a template for replying generated and displayed in real-time, execution of the method may provide a technical solution to the challenge of recommending a plurality of words (including, e.g., entire messages, letters, and extended communications) while satisfying a threshold level of accuracy and providing the template in sufficient time to prevent a user from simply beginning to type. Such a smart reply may be in the form of a template. However, such a smart reply may also be an entire reply generated by large language models implementing generative artificial intelligence.

The method 400 includes determining, by the recommendation generation engine, a plurality of candidate input recommendations, based on analyzing the at least one word (406). The recommendation generation engine may determine the plurality of candidate input recommendations as described above in connection with FIG. 1A, (no). The method may include execute a large language model (e.g., such as a large language model executed by the recommendation generation engine depicted in FIG. 2B) and generate a response fine-tuned based upon analyses of data associated with the user and/or entities of which the user is a part. In some embodiments, the response generation engine executes one or more application programming interface calls to interact with third party machine learning engines and/or large learning models.

The method 400 includes identifying, by the recommendation generation engine, a subset of the plurality of candidate input recommendations, each of the subset associated with a confidence score that satisfies a threshold level of confidence (408). The recommendation generation engine may identify the subset as described above in connection with FIG. 1A, (112).

The method 400 includes modifying, by the recommendation generation engine, a graphical user interface displayed to the user to include a display of at least one of the identified subset associated with the confidence score that satisfies a threshold level of confidence (410).

By prepopulating templates with information about a specific user and a specific context, the method may provide improved, real-time user input recommendations.

The sentence extraction model may provide some or all of the plurality of recommendations, with or without associated scores, to the system for display to the user with a request for input indicating whether to accept the recommendation. The user provides feedback regarding whether or not to accept the recommendation, this feedback may also be used to score future recommendations. If the sentence extraction model does not identify a recommendation, the sentence extraction model may transmit an instruction to the neural network to analyze the user input and determine whether to make a recommendation for an addition to the user input or a correction of the user input, as described above in connection with FIGS. 1-3.

In some embodiments, the system includes functionality for recognizing and removing templates from a corpus text prior to training components on sample documents or identifying one or more words to use in subsequent input recommendations. In a corporate setting, for example, corpus documents may include identical messages that companies use to reply to similar requests—an automatic indication, for example, that a support request has been received and will be responded to within a certain number of business days. Such text is unlikely to be useful in generating a recommendation for text that a user should include in user input and would negatively impact subsequent training of either neural networks or sentence extraction models. Therefore, the system may include functionality to identify the templates and remove them from the corpus. The identified templates themselves may be identified as recommendations for a certain kind of user input and not for another—for example, if a user is generating input in the context of responding to a request for support, the system will be less likely to recommend text identified as a “template”—but if the user is generating input in the context of creating automated messages that indicate support requests have been received (or confirming a transaction or confirming resolution of an issue or other automated message), then text identified as a “template” may be recommended. One approach to identifying the template text is to take an approach leveraging a percentage of common text. This approach may be implemented, for example, when an organization can provide a list of existing templates—by executing a diffing algorithm between each provided template and each message in the corpus text and determining whether a threshold number of words from the template are present in the message in the corpus text in substantially the same order, the system can determine that that portion of the text is a template and flag either part or all of the message as template text to be excluded from training processes (unless training for template text recommendation). Another approach to identifying template text is to cluster messages using clustering algorithms, such as glove word embeddings (and/or one or more other clustering algorithms with high thresholds for cluster creation); if a message appears in a cluster, it is identified as a template. The method may execute an algorithm for detecting duplicates or near duplicates; for example, the method may execute an algorithm such as the MinHash algorithm described at https://skeptric.com/minhash/.

In some embodiments, the method includes training a sentence extraction model to determine how to extract one or more words from one document or collection of words to include in a plurality of candidate recommendations for a given set of user input. Given a corpus text, in one example, the method may include building word-level ngrams, from bi-grams up to K-grams, where K is usually at or about 30; the method may include summing the counts of the ngrams at the corpus level and scoring each ngram based on its count and its length—as an example, a common bigram may receive a lower score than a less common 9-gram. In another example, given the corpus text, the method may include tokenizing the corpus text at the word level, reviewing the corpus and merging two adjacent tokens with the highest score and re-scoring the corpus as a computation of character length of the pair and the frequency of the pair in the corpus; the method may include repeating the process and considering the highest scoring two adjacent tokens as a single corpus (e.g., a single sentence, candidate/suggestion, or group of words); the method may include repeating the process until either there are no more single-word tokens to be merged or until a certain amount of merge operations (e.g., 30000)—this approach may provide increased level of flexibility than the ngram approach because it allows for longer sentences to be captured in case the longer sentences are very common.

In some embodiments, the training process may be modified to improve the models used in entity-specific datasets. For example, by analyzing a dataset of user input received from a plurality of users associated with a company, the system may be trained to improve the model such that company specific language is incorporated into the model. For example, the method may include pretraining (e.g., a neural network) on general data with synthetic errors (e.g., 10 million sentences), finetuning the model with company-specific data also including synthetic errors (e.g., 100,000 sentences, and, if an optional grammar correction dataset is included, (e.g., training the model on English and German only), executing a second finetuning process on real data with early stopping on a held-out validation set (e.g., 20,000 sentences); half of the validation set may include company data and half of the validation set may be grammar correction data so that the model has a balance between company data and grammar data.

In some embodiments, the system therefore includes functionality for generating synthetic data for use in training the models executed by the methods described herein. The system may also include functionality for training models with unlabeled data. For languages other than English where there is insufficient grammar correction data available, the system may generate synthetic data for the machine learning models; some approaches for doing so include using probabilities for word substitution, insertion, deletion, and replacement. The methods described herein may include functionality for approaching the process by replacing verbs with the same verb but in other forms, nouns with nouns in different cases or genders, pronouns with other pronouns, etc.; such an approach allows the method to generate errors that are more realistic and can be used for training language models specific to any language, even without a pre-existing dataset. Another approach provided the methods described herein is to use client usage data to enhance the training data set. For example, the method may access analytics data to analyze user instructions regarding correction suggestions (e.g., whether or not to implement particular suggestions, whether spelling, grammar, or phrase or template completion); such an approach allows the method to iteratively improve the model (e.g., the model performed poorly on capitalization and comma insertion, so the method may next finetune the generation process to force the model to learn more of these mistakes; or the method may determine based on analyzing user input that users do not typically select certain suggestions and the method may then determine not to add the errors identified and corrected for by those suggestions into the model, or may change the weighting given to such errors). The methods may include functionality for modifying a user interface display of user input to identify areas where corrections and/or recommendations are being provided. By way of example, the method may underline two words and suggest inserting a word between the two. When the suggestion is to add punctuation, the method may underline the word preceding the recommended punctuation mark. When the suggestion is to delete a word, the method may underline both the previous and next word or just the word itself, making the determination as to which to underline based on the length of the word.

Using the approaches described herein, the methods and systems described may provide grammar correction for languages that do not currently have any grammar correction data available and for which conventional approaches do not provide grammar correction recommendations.

In some embodiments, the system includes non-transitory, computer-readable medium comprising computer program instructions tangibly stored on the non-transitory computer-readable medium, wherein the instructions are executable by at least one processor to perform the methods described above.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The terms “A or B”, “at least one of A and/or B”, “at least one of A and B”, “at least one of A or B”, or “one or more of A and/or B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the methods and systems described herein may be implemented in any programming language, such as assembly language, machine language, a high-level procedural programming language, or an object-oriented programming language. The programming language may, for example, be LISP, PROLOG, PERL, C, C++, C#, JAVA, SCALA, PYTHON, TYPESCRIPT, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random-access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, and so on.

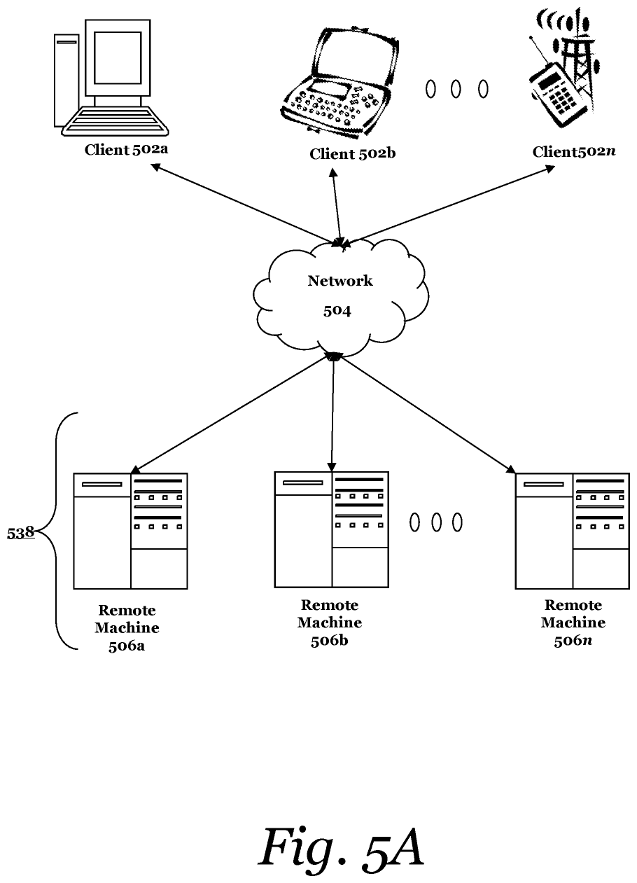

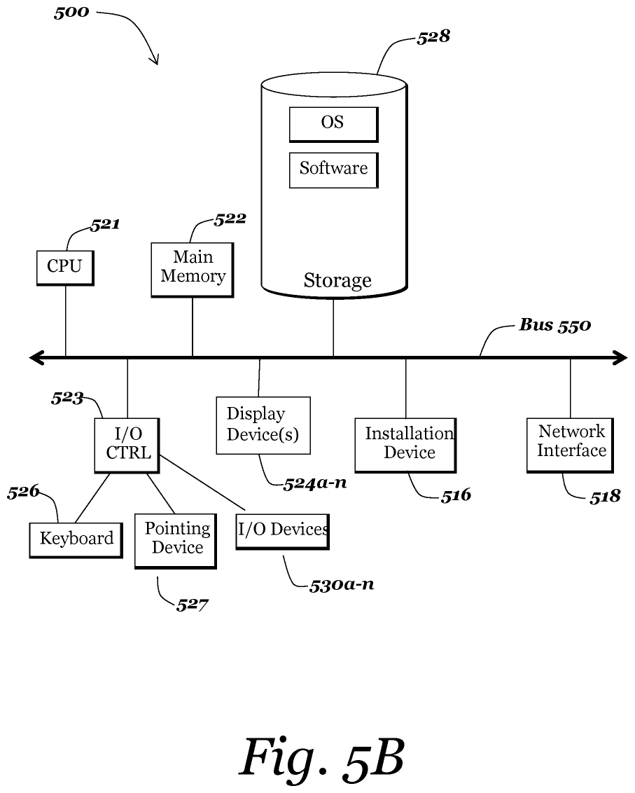

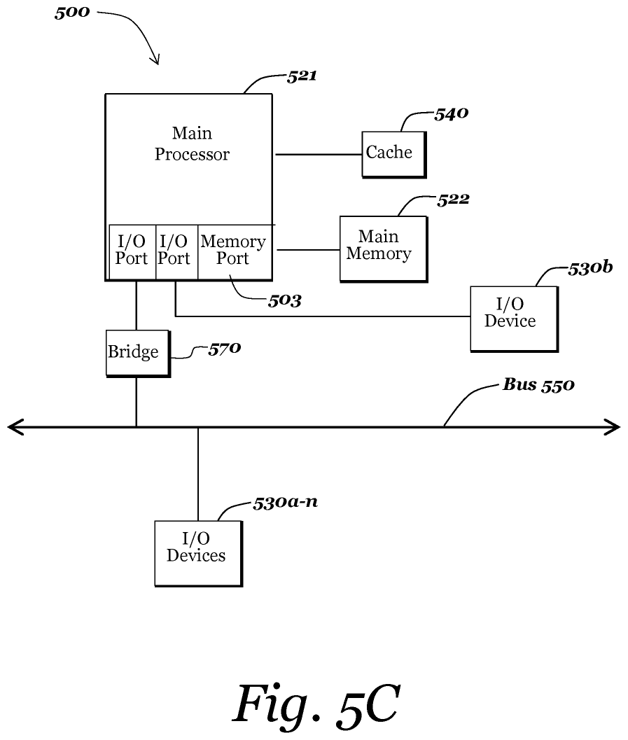

Referring now to FIGS. 5A, 5B, and 5C, block diagrams depict additional detail regarding computing devices that may be modified to execute novel, non-obvious functionality for implementing the methods and systems described above.

Referring now to FIG. 5A, an embodiment of a network environment is depicted. In brief overview, the network environment comprises one or more clients 502a-502n (also generally referred to as local machine(s) 502, client(s) 502, client node(s) 502, client machine(s) 502, client computer(s) 502, client device(s) 502, computing device(s) 502, endpoint(s) 502, or endpoint node(s) 502) in communication with one or more remote machines 506a-506n (also generally referred to as server(s) 506 or computing device(s) 506) via one or more networks 504.

Although FIG. 5A shows a network 504 between the clients 502 and the remote machines 506, the clients 502 and the remote machines 506 may be on the same network 504. The network 504 can be a local area network (LAN), such as a company Intranet, a metropolitan area network (MAN), or a wide area network (WAN), such as the Internet or the World Wide Web. In some embodiments, there are multiple networks 504 between the clients 502 and the remote machines 506. In one of these embodiments, a network 504′ (not shown) may be a private network and a network 504 may be a public network. In another of these embodiments, a network 504 may be a private network and a network 504′ a public network. In still another embodiment, networks 504 and 504′ may both be private networks. In yet another embodiment, networks 504 and 504′ may both be public networks.

The network 504 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 504 may comprise a wireless link, such as an infrared channel or satellite band. The topology of the network 504 may be a bus, star, or ring network topology. The network 504 may be of any such network topology as known to those ordinarily skilled in the art capable of supporting the operations described herein. The network 504 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 502 and a remote machine 506 (referred to generally as computing devices 500 or as machines 500) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 502 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 502.

In one embodiment, a computing device 506 provides functionality of a web server. The web server may be any type of web server, including web servers that are open-source web servers, web servers that execute proprietary software, and cloud-based web servers where a third party hosts the hardware executing the functionality of the web server. In some embodiments, a web server 506 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the ORACLE WEBLOGIC products provided by Oracle Corporation of Redwood Shores, CA.

In some embodiments, the system may include multiple, logically-grouped remote machines 506. In one of these embodiments, the logical group of remote machines may be referred to as a server farm 538. In another of these embodiments, the server farm 538 may be administered as a single entity.

FIGS. 5B and 5C depict block diagrams of a computing device 500 useful for practicing an embodiment of the client 302 or a remote machine 506. As shown in FIGS. 5B and 5C, each computing device 500 includes a central processing unit 521, and a main memory unit 522. As shown in FIG. 5B, a computing device 500 may include a storage device 528, an installation device 516, a network interface 518, an I/O controller 523, display devices 524a-n, a keyboard 526, a pointing device 527, such as a mouse, and one or more other I/O devices 530a-n. The storage device 528 may include, without limitation, an operating system and software. As shown in FIG. 5C, each computing device 500 may also include additional optional elements, such as a memory port 503, a bridge 570, one or more input/output devices 530a-n (generally referred to using reference numeral 530), and a cache memory 540 in communication with the central processing unit 521.

The central processing unit 521 is any logic circuitry that responds to and processes instructions fetched from the main memory unit 522. In many embodiments, the central processing unit 521 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, and processors for mobile devices. The computing device 500 may be based on any of these processors, or any other processor capable of operating as described herein.

Main memory unit 522 may be one or more memory chips capable of storing data and allowing any storage location to be directly accessed by the microprocessor 521. The main memory 522 may be based on any available memory chips capable of operating as described herein. In the embodiment shown in FIG. 5B, the processor 521 communicates with main memory 522 via a system bus 550. FIG. 5C depicts an embodiment of a computing device 500 in which the processor communicates directly with main memory 522 via a memory port 503. FIG. 5C also depicts an embodiment in which the main processor 521 communicates directly with cache memory 540 via a secondary bus, sometimes referred to as a backside bus. In other embodiments, the main processor 521 communicates with cache memory 540 using the system bus 550.

In the embodiment shown in FIG. 5B, the processor 521 communicates with various I/O devices 530 via a local system bus 550. Various buses may be used to connect the central processing unit 521 to any of the I/O devices 530, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 524, the processor 521 may use an Advanced Graphics Port (AGP) to communicate with the display 524. FIG. 5C depicts an embodiment of a computing device 500 in which the main processor 521 also communicates directly with an I/O device 530b via, for example, HYPERTRANSPORT, RAPIDIO, or INFINIBAND communications technology.

One or more of a wide variety of I/O devices 530a-n may be present in or connected to the computing device 500, each of which may be of the same or different type and/or form. Input devices include physical keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 523 as shown in FIG. 5B. Furthermore, an I/O device may also provide storage and/or an installation medium 516 for the computing device 500. In some embodiments, the computing device 500 may provide USB connections (not shown) to receive handheld USB storage devices such as the USB Flash Drive line of devices manufactured by Twintech Industry, Inc. of Los Alamitos, CA.

Referring still to FIG. 5B, the computing device 500 may support any suitable installation device 516, such as hardware for receiving and interacting with removable storage; e.g., disk drives of any type, CD drives of any type, DVD drives, tape drives of various formats, USB devices, external hard drives, or any other device suitable for installing software and programs. In some embodiments, the computing device 500 may provide functionality for installing software over a network 504. The computing device 500 may further comprise a storage device, such as one or more hard disk drives or redundant arrays of independent disks, for storing an operating system and other software. Alternatively, the computing device 500 may rely on memory chips for storage instead of hard disks.

Furthermore, the computing device 500 may include a network interface 518 to interface to the network 504 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 500 communicates with other computing devices 500′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 518 may comprise a built-in network adapter, network interface card, PCMCIA network card, card bus network adapter, wireless network adapter, USB network adapter, modem, or any other device suitable for interfacing the computing device 500 to any type of network capable of communication and performing the operations described herein. In further embodiments, an I/O device 530 may be a bridge between the system bus 550 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 500 of the sort depicted in FIGS. 5B and 5C typically operates under the control of operating systems, which control scheduling of tasks and access to system resources. The computing device 500 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 7, WINDOWS 8, WINDOWS VISTA, WINDOWS 10, and WINDOWS 11 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for generating and providing user input recommendations, it will be apparent to one of skill in the art that other embodiments incorporating the concepts of the disclosure may be used.

What is claimed is:

1. A computer-implemented method for generating and providing a user input recommendation, the method comprising:
receiving, by a recommendation generation engine, an indication that a message addressed to a user has been received;
analyzing, by the recommendation generation engine, at least one word within the message;
determining, by the recommendation generation engine, a plurality of candidate input recommendations, based on analyzing the at least one word;
identifying, by the recommendation generation engine, a subset of the plurality of candidate input recommendations, each of the subset associated with a confidence score that satisfies a threshold level of confidence; and
modifying, by the recommendation generation engine, a graphical user interface displayed to the user to include a display of at least one of the identified subset associated with the confidence score that satisfies a threshold level of confidence.

2. The method of claim 1 further comprising analyzing, by a sentence extraction model in communication with the recommendation generation engine, at least one message previously addressed to the user.

3. The method of claim 1 further comprising analyzing, by a sentence extraction model in communication with the recommendation generation engine, at least one message composed and sent out by the user.

4. The method of claim 1, wherein determining the plurality of candidate input recommendations further comprises determining a plurality of candidate input recommendations for use in composing a response to the received message.

5. The method of claim 1, wherein modifying further comprises prepopulating the graphical user interface with a pre-written message responding to the received message.

6. The method of claim 1, wherein determining further comprises identifying a template for use in prepopulating, in conjunction with at least one of the plurality of candidate input recommendations, the graphical user interface with a pre-written message responding to the received message.

7. The method of claim 1, wherein identifying further comprises identifying, by the recommendation generation engine, prior to displaying the received message to the user, a subset of the plurality of candidate input recommendations, each of the subset associated with a confidence score that satisfies a threshold level of confidence.

8. A computer-implemented method for generating and providing a user input recommendation, the method comprising:
receiving, by a graphical user interface provided by an application executing on a computing device, user input representing at least a first word entered by a user of the computing device, the first word including at least one character;
accessing, by the application, at least one word entered by the user prior to the entering of the first word;
analyzing, by the application, the first word and the at least one word entered prior to the entering of the first word;
determining, by the application, a plurality of candidate input recommendations, based on analyzing the first word and the at least one word entered prior to the entering of the first word;
identifying, by the application, a subset of the plurality of candidate recommendations, each of the subset associated with a confidence score that satisfies a threshold level of confidence; and
modifying, by the application, the graphical user interface to include a display of at least one of the identified subset associated with the confidence score that satisfies a threshold level of confidence.

9. The method of claim 8 further comprising, before accessing the at least one word entered by the user prior to the entering of the first word, determining, by the application that the user has completed entering the first word.

10. The method of claim 8 further comprising selecting the plurality of candidate input recommendations from a database of words associated with the user.

11. The method of claim 8 further comprising selecting the plurality of candidate input recommendations from a database of words associated with a type of an application for which the user input is provided.

12. The method of claim 8 further comprising selecting the plurality of candidate input recommendations from a database of words associated with an employer of the user.

13. The method of claim 8 further comprising selecting the plurality of candidate input recommendations from a database of words associated with a group of users that includes the user providing the user input.

14. The method of claim 8 further comprising selecting the plurality of candidate input recommendations from a dictionary including words in a dialect of a language.

15. The method of claim 8, wherein identifying the subset of the plurality of candidate input recommendations further comprises executing, by the application, a neural network component to determine a probability of a candidate input recommendations having a threshold level of accuracy.

16. The method of claim 8 further comprising identifying a context associated with the user input.

17. The method of claim 16, wherein determining, by the application, the plurality of candidate input recommendations, includes determining the plurality of candidate input recommendations based on analyzing at least the first word and the identified context.

18. The method of claim 8 further comprising receiving user input including an instruction to replace the first word with the at least one of the identified subset.

19. The method of claim 8 further comprising receiving user input including an instruction not to replace the first word with the at least one of the identified subset.

20. The method of claim 8 further comprising receiving user input including an instruction to add the first word to the dictionary.
